(19) United States
(12) Patent Application Publication
(10) Pub. No.: US 2026/0303716 A1
(43) Pub. Date: Oct. 1, 2026

(54) METHOD AND FOLDABLE DEVICE FOR QUICK ACCESS TO APPLICATIONS AND FEATURES BASED ON DEVICE ORIENTATION, ROTATION, AND TRANSLATION

(71) Applicant: MOTOROLA MOBILITY LLC, WILMINGTON, DE (US)

(72) Inventors: QING-SHUAI ZHU, NAPERVILLE, IL (US); XIAOFENG ZHU, NANJING CITY (CN)

(21) Appl. No.: 19/177,071

(22) Filed: Apr. 11, 2025

Related U.S. Application Data
(63) Continuation of application No. PCT/CN2025/086668, filed on Apr. 1, 2025.

(51) Int. Cl. H04M 1/02

(52) U.S. Cl. CPC H04M 1/0206

(57) ABSTRACT

A method of triggering applications or features by moving a flip phone through a sequence of motions. The method includes sensing an initial orientation of the phone in a closed configuration within a palm of a user. The method includes detecting a sequence of motions involving the phone being reconfigured from the initial orientation and closed configuration to an axially open position within the palm. The method includes matching the sequence of motions from the initial orientation with a first device gesture associated with at least one of a plurality of predetermined commands for activating specified applications or features on the phone. The method includes, in response to matching the sequence of motions to a first device gesture that corresponds to a predetermined command, triggering activation of a specified application or feature corresponding to the predetermined command.

### CLAIM FOR PRIORITY

This application is a continuation of International Application No. PCT/CN2025/086668, filed on Apr. 1, 2025, the contents of which are incorporated herein by reference.

### BACKGROUND

### 1. Technical Field

The present disclosure generally relates to electronic devices with foldable form factor, and more specifically to foldable electronic devices configured for manual opening.

### 2. Description of the Related Art

Handheld electronic communication devices allow for continuous access to any number of internet applications or practical functions. Smartphones for example, allow for quick access to social media and electronic banking applications and also provide electronic day planners, calculators, and other user applications. Such versatility has allowed handheld electronic communication devices to effectively replace devices ranging from full-sized computers to flashlights, making them indispensable to their owners. These devices come in various form factors, with the two most common being a candy bar form factor and a clamshell or flip form factor.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement motion activated device actuation, according to one or more embodiments;

FIG. 1B is an additional block diagram representation of the electronic device of FIG. 1A presenting additional components, including components for wireless communications with other devices within a connected device ecosystem, according to one or more embodiments;

FIG. 1C depicts a front flat view of an example electronic device, presented as a flip phone having a top housing and a bottom housing that are connected via a centrally located hinge, according to one or more embodiments;

FIG. 1D depicts a back flat view of the example electronic device of FIG. 1C, according to one or more embodiments;

FIG. 1E is a view of the top portion of the electronic device described in FIG. 1D, having the folding housing in the closed position, according to one or more embodiments;

FIG. 1F is a view of the bottom portion of the electronic device described in FIG. 1D, having the folding housing in the closed position, according to one or more embodiments;

FIGS. 2A-2D depict a plurality of different sequences of motion whereby the electronic device is reconfigured from a closed position to an axially displaced open position, each of the respective sequences of motion having the same initial electronic device orientation, according to a plurality of embodiments;

FIGS. 3A-3D depict a second plurality of different sequences of motion whereby the electronic device is reconfigured from a closed position to an axially displaced open position, each of the respective sequences of motion having a different initial electronic device orientation, according to a plurality of embodiments;

FIGS. 4A-4D depict a third plurality of different sequences of motions whereby the communication device is reconfigured from a closed position to an axially displaced open position, each sequence of motions including two of a rotation of the electronic device along the longitudinal axis, a rotation of the electronic device along the depth axis, or pausing and/or reversing the rotation of the first housing while displacing the first housing axially from the second housing before the electronic device reaches an axially displaced open position, according to a plurality of embodiments;

FIG. 5 depicts an exemplary device gesture mapping table populated with predetermined commands and corresponding applications or modes of operation executed when the electronic device is reconfigured from a closed position to an axially displaced open position via a specified sequence of motions, according to one or more embodiments;

FIG. 6 depicts a flow diagram presenting a method for motion activated device actuation, according to one or more embodiments;

FIG. 7 depicts a flow diagram presenting an additional method for motion activated device actuation, according to one or more embodiments.

### DETAILED DESCRIPTION

According to aspects of the present disclosure, an electronic device, a method, and a computer program product enable activation/implementation of an application or mode of operation on an electronic device in response to a sequence of motions recognized as a preset command gesture. More specifically, a handheld electronic communication device with a folded form factor may be flipped, rotated, moved through a range of open and closed positions, in one or more selected combinations thereof in order to pass the electronic communication device through a sequence of movements that corresponds to one of a plurality of commands found in a preset gesture command table stored in the device.

Traditionally, gaining access to applications or modes of operation on a smartphone or similar electronic communication device involves depressing physical buttons or elements (e.g., icons) of a tactile screen interface as directed by a graphical user interface (GUI). The device must be placed in a mode that allows user input. For foldable devices, placing the device in an operational mode for activating/selecting/initiating the majority of the features and applications on the device typically involves opening the device from a fully closed position to a fully opened position to expose the physical buttons and/or GUI. To ensure that the correct functionality is selected, the user will then manually select the activation element presented within the GUI from options rendered within the GUI. While this process yields the desired result, such a process is relatively time consuming. Moreover, it may be advisable to steady the device with one hand while selection is made with the other hand as to avoid unintentional selection of undesired applications or functions due to the device slipping, this requiring two hands to trigger/initiate the desired function/feature.

In accordance with some aspects of the present disclosure, the relatively slow pace of selection and the risk of selecting undesired functionality are overcome by enabling the flip phone to be pre-configured to effect selection/activation of specific functionality without the need to interact with buttons or the GUI. In the presented embodiments, selection of different functionality, such as activation of specific applications or functions on the device, is accomplished with single handed horizontal and vertical rotational movements of the device using the wrist and fingers to open the device. The present disclosure eliminates the need for the user to have to view or depress buttons and/or graphical elements associated with the more traditional selection process, which also involves first opening the device and possibly also toggling to the correct screen presenting the manually selectable application element.

According to one embodiment, the electronic device includes a foldable enclosure comprising a first housing and a second housing coupled by a hinge such that the first housing is pivotable about the hinge relative to the second housing between a closed position and an axially displaced open position. The electronic device includes at least one image capturing device comprising a first rear facing camera embedded in a first surface of the first housing, the first surface being an outward facing surface of the first housing. The electronic device includes a plurality of sensors comprising: (a) at least one pivot sensor operable to determine an angle of rotation when the first housing is pivoted about the hinge relative to the second housing and a configuration of the electronic device between the closed position, a partially open substantially orthogonal position, and the axially displaced open position, and (b) one or more device spatial sensors operative to detect a relative orientation and position of the electronic device, while in the closed position and supported in a palm of a hand of a user. The electronic device includes a memory having stored thereon a rotation, translation, and activation (RTA) module that configures the electronic device to interpret opening movements of the device housing following different initial device orientations as different activation gestures for respectively activating applications and other features on the electronic device. The electronic device includes at least one processor communicatively coupled to the at least one image capturing device, each of the plurality of sensors, and the memory, the at least one processor executing program code of the RTA module. The at least one processor is configured to cause the electronic device to sense an initial orientation of the electronic device in a closed configuration within the palm of the user and detect a sequence of motions/movements involving the electronic device being reconfigured from the initial orientation and closed configuration to potentially a different orientation and to an axially open position within the palm of the user. The at least one processor is configured to cause the electronic device to match the sequence of motions/movements from the initial orientation and closed position to a final open position with a first device gesture associated with at least one of a plurality of predetermined commands for activating specified applications or features on the electronic device. The at least one processor is configured to cause the electronic device to, in response to matching the sequence of motions to a first device gesture that corresponds to a predetermined command, trigger activation of a specified application or feature corresponding to the predetermined command.

According to one aspect of the disclosure, a method is disclosed for implementing motion activated device actuation. The method includes sensing an initial orientation of an electronic device in a closed configuration within a palm of a user of the electronic device. The method includes detecting a sequence of motions/movements involving the electronic device being reconfigured from the initial orientation and closed configuration to potential a next orientation and to an axially open position within the palm of the user. The method includes matching the sequence of motions/movements from the initial orientation with a first device gesture associated with at least one of a plurality of predetermined commands for activating specified applications or features on the electronic device. The method includes, in response to matching the sequence of motions to a first device gesture that corresponds to a predetermined command, triggering activation of a specified application or feature corresponding to the predetermined command.

Also disclosed is a computer program product comprising a non-transitory computer readable medium having computer program product instructions, that when executed by a processor of an electronic device, configures the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program products include a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. does not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

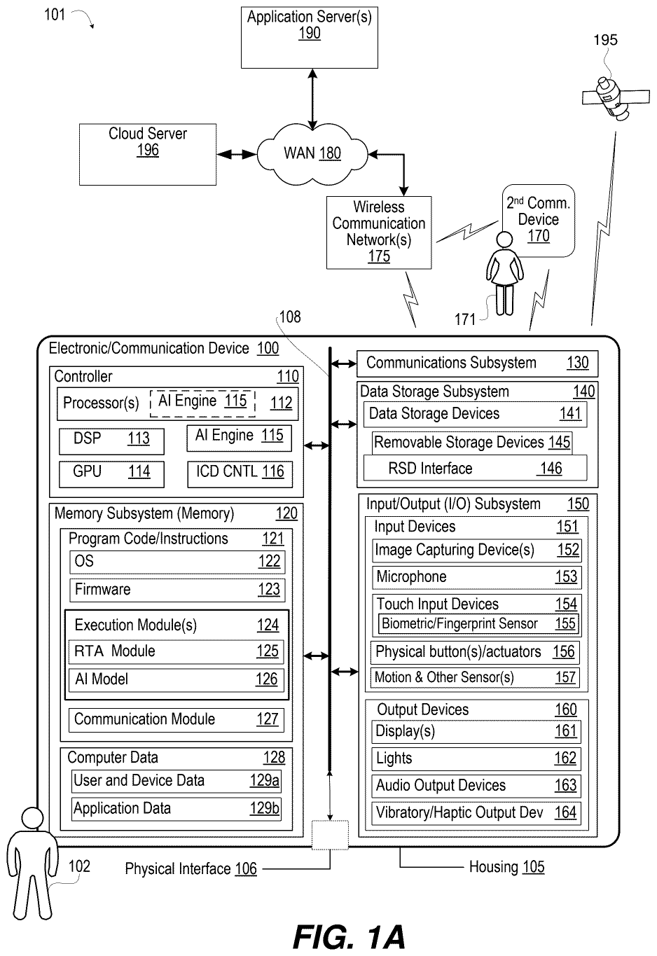

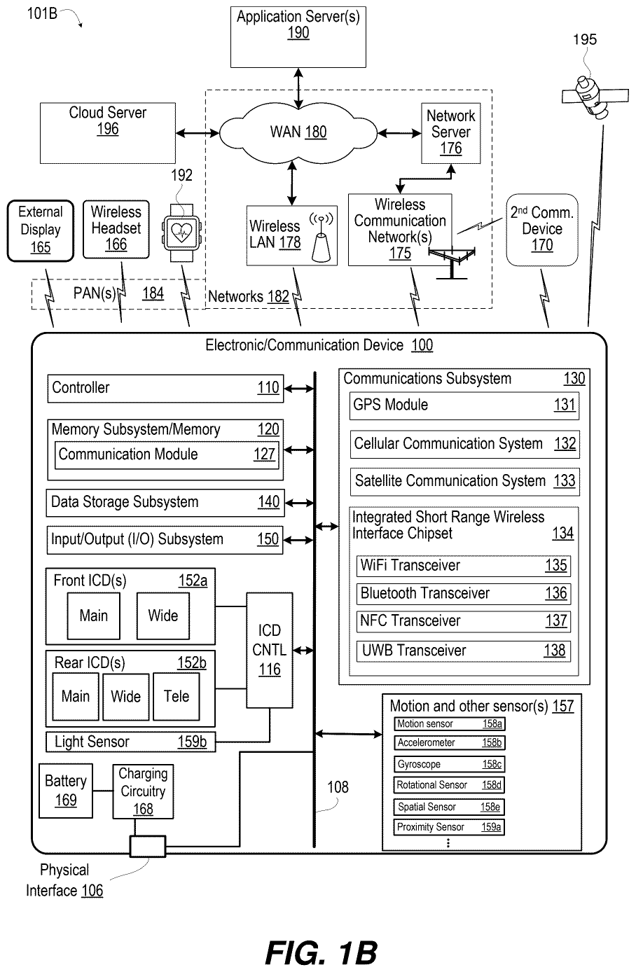

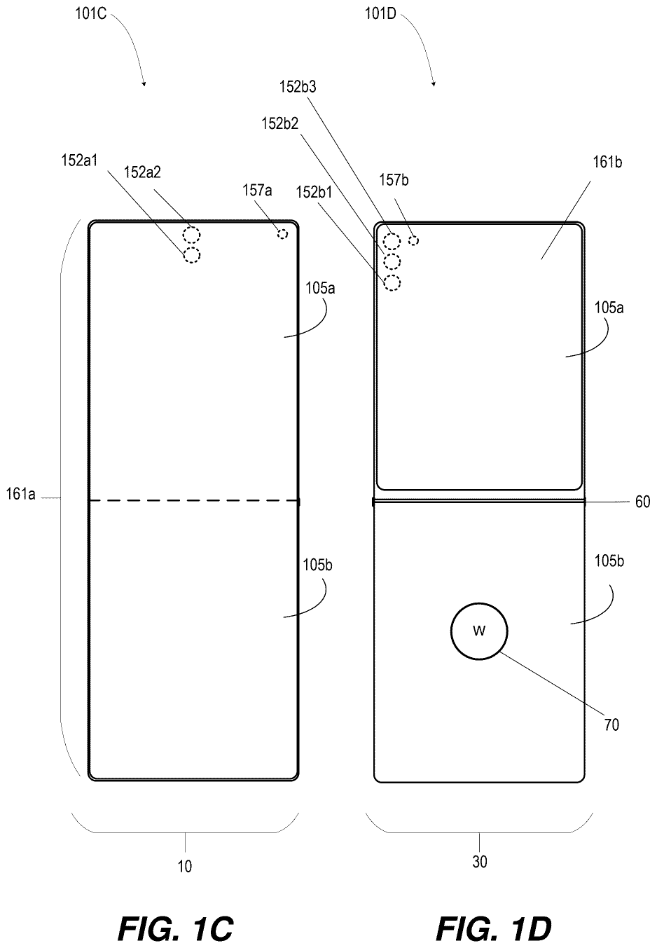

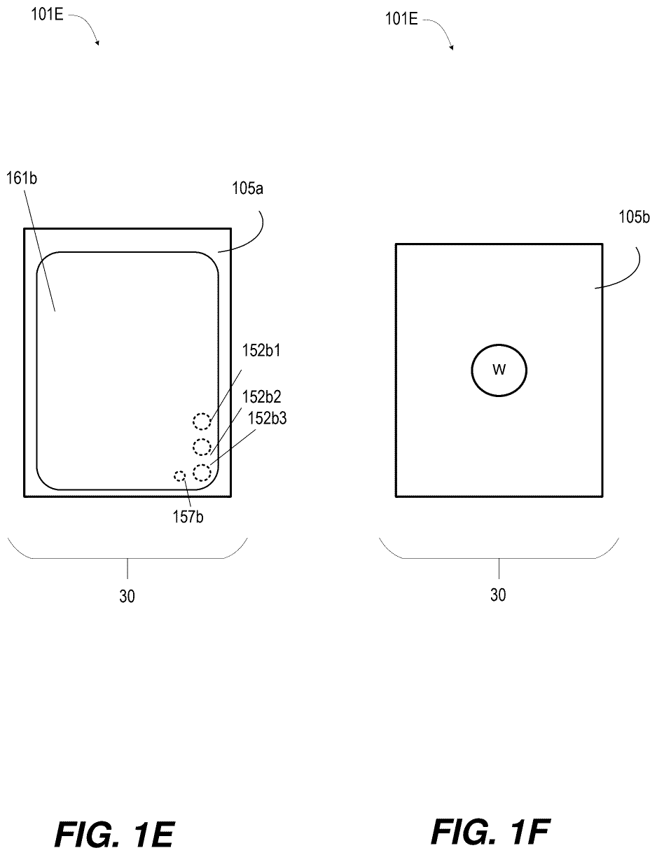

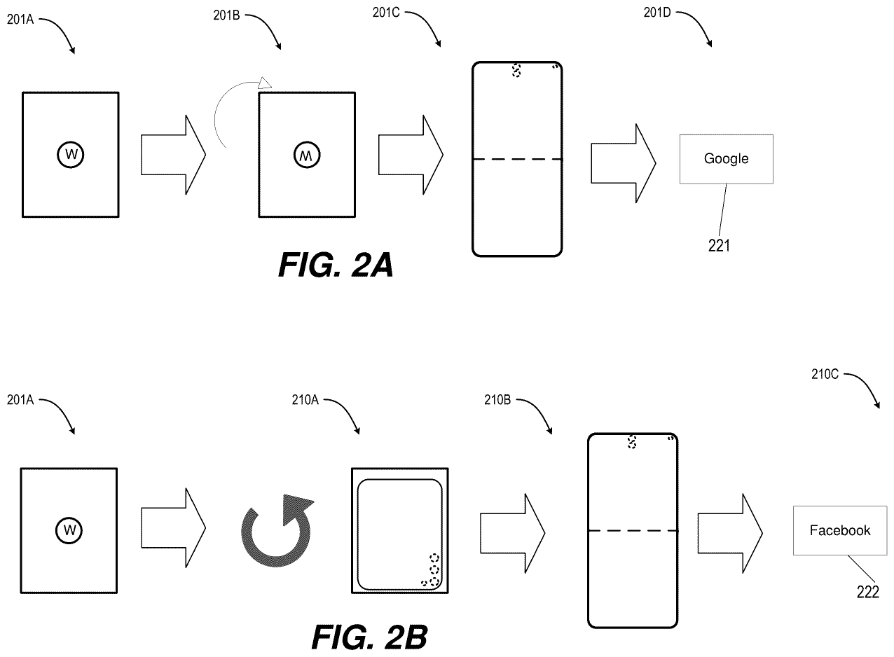

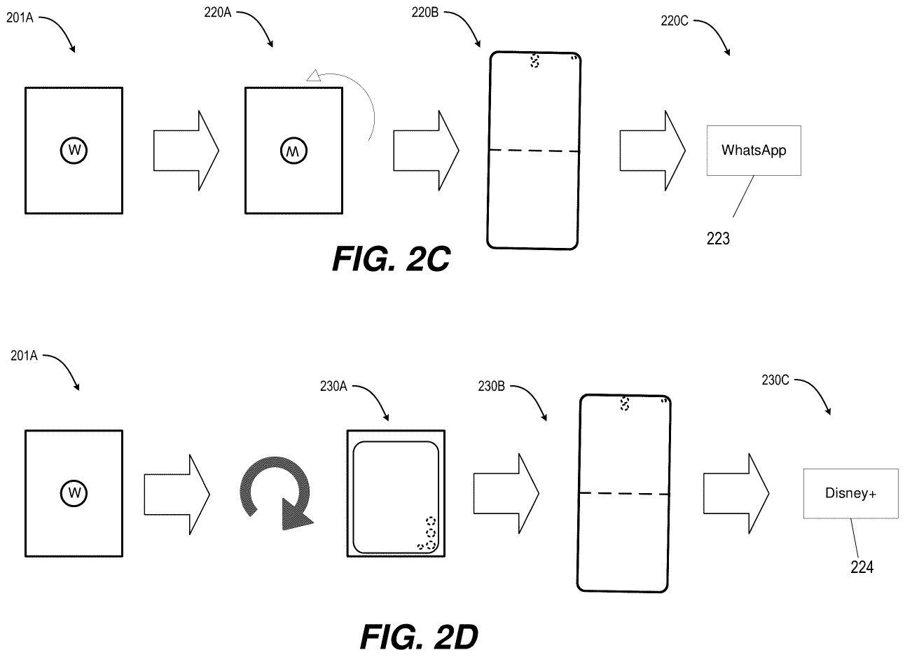

Referring now to the figures and beginning with FIG. 1A, there is illustrated a block diagram of an example electronic device 100 in a communication environment 101 and having hardware and software components, which enable the features of the present disclosure to implement a joint response for a group of related electronic devices, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of the description of the various embodiments herein, FIG. 1 (FIG. 1A and FIG. 1B) is presented as/from the perspective of electronic device 100, which is the device operative to implement functionality in response to movement sequences that correspond to predetermined commands. FIGS. 2A-2D, 3A-3D, and 4A-4D present exemplary motion sequences that the electronic device 100 may undergo (through actions of a user) to invoke applications, device features, or modes of operation desired by the user 102.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. As shown by FIGS. 1C-1D and 2A-2D, 3A-3D, and 4A-4D, described hereafter, device housing 105 includes two separate housing portions that are connected via a joint or hinge section to allow for rotation of one portion of the housing relative to the other. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, rotation, translation, and activation (RTA) module 125, which provides the features and operating functionality of the disclosed embodiments when the corresponding program instructions of RTA module 125 are processed by/within processor 112/controller 110. Specifically, RTA module 125 provides program instructions for sensing the initial orientation of the electronic device 100 in a closed position, sensing and tracking a sequence of motions consisting of subsequent horizontal and/or vertical rotation of the electronic device 100 and rotation of the first housing relative to the second housing so that the first housing 105a is axially displaced from the second housing 105b, comparing the sequence of motions to entries within a device gesture mapping table in data storage 140, based on identifying a match to one of the entries, retrieving a corresponding preset function from the device gesture mapping table and triggering execution of the corresponding preset function on the electronic device 100.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within RTA module 125 and is trained to support the AI features of RTA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, RTA module 125 can include program instructions that cause or configure controller 110 or processor 112 to cause electronic device 100 to sense an initial orientation of the electronic device 100 in a closed configuration within the palm of the user 102. The controller 110 is further configured to cause the electronic device 100 to detect and track/record a sequence of motions/movements involving the electronic device 100 being reconfigured from the initial orientation and closed configuration to an axially open position within the palm of the user 102. The controller 110 is further configured to cause the electronic device 100 to match the sequence of motions from the initial orientation with a first device gesture associated with at least one of a plurality of predetermined commands for activating specified applications or features on the electronic device 100. The controller 110 is further configured to cause the electronic device 100 to, in response to matching the sequence of motions to a first device gesture that corresponds to a predetermined command, trigger activation of a specified application or feature corresponding to the predetermined command.

In a further embodiment, controller 110, prior to triggering activation of the specified application or feature, is further configured to cause the electronic device 100 to prompt the user 102 to confirm an intention to invoke the predetermined command. The controller 110 is further configured to cause the electronic device 100 to initiate triggering of the activation, in response to receipt of confirmation that the user intended to invoke the predetermined command.

In another embodiment, the initial orientation of the electronic device 100 is one from among a group of different hand held orientations comprising: (i) a plurality of faced-upwards orientations presenting the first surface of the electronic device 100 facing away from the palm of the user 102, and (ii) a plurality of faced-downwards orientations with the first surface facing and covered by the palm of the user 102, with a second surface of the electronic device 100, opposed to the first surface, facing away from the palm of the user 102.

In a further embodiment, the plurality of faced-upwards orientations and faced-downwards orientations comprise: a default upright orientation that is a normal upright mode of device usage that supports a flip up of the first housing while gripping the second housing in the palm of the user 102, and one or more of a second orientation rotated 90 degrees clockwise from the default orientation, a third orientation rotated 180 degrees from the default orientation, and a fourth orientation that is rotated 270 degrees clockwise or −90 degrees counter-clockwise from the default orientation, wherein the default orientation is a zero phase orientation. It is appreciated that the use of specific degrees of rotation is solely for example. Other degrees of rotations can be defined and used to trigger the various functions that are in part activated based on the initial device orientation and subsequent device orientations transposed from the initial orientation.

In another embodiment, the sequence of motions involving the electronic device 100 being reconfigured from the initial orientation and closed configuration to an axially open position within the palm of the user 102 comprise at least two sequential motions from among rotating the electronic device 100 in the palm of the user 102 from an initial default orientation along a height/depth axis, rotating the electronic device 100 in the palm of the user 102 along a longitudinal axis by a preset number of degrees, and rotating the first housing relative to the second housing so that the first housing is axially displaced from the second housing at one or more angles between a closed position and an end of range of motion of the hinge. In some embodiments, the end of range of motion corresponds to a fully open position of the device housing.

In another embodiment, the sequence of motions further comprises pauses in a rotation of the first housing away from or towards the second housing prior to the first housing being axially displaced at a final angle between a closed position and a fully open position with the second housing, each pause occurring at a predetermined intermediate angle for a preset time period, the rotations being uni-directional or bi-directional rotations. With uni-directional rotations the pauses occur as the device housing is rotated in only the direction of opening the device housing, with the pauses in rotation being for greater than the preset time period so as to ensure the pause is intentional/deliberate. With bi-directional rotations, the device housing is rotated in the open direction (i.e., a positive or increasing angle of rotation) followed by a rotation in the closed direction (i.e., a negative or decreasing angle of rotation), and the pauses are inferred by the reverse or the negative angle of rotation that follows a positive angle of rotation and vice versa, as the change in direction is assumed to be intentional/deliberate. The controller 110 is configured to cause the electronic device 100 to compare the sequence of motions including each pause and an angle/amount of rotation at each pause within a device gesture mapping table. The controller 110 is further configured to cause the electronic device 100 to, in response to detecting a match of the sequence of motions to an entry within the device gesture mapping table, retrieve a corresponding preset function from the device gesture mapping table, and trigger execution of the corresponding preset function on the electronic device.

In one or more embodiments, the one or more spatial sensors comprise pressure sensors operative to sense the palm of the user on one of the first housing or the second housing and changes in pressure that can be indicative of rotation associated with device gestures.

In one or more embodiments, the one or more sensors comprise at least one accelerometer and at least one gyroscope operative to detect rotational movement of the electronic device in a closed position.

In another embodiment, the predetermined commands for activating specified applications or features on the electronic device comprise: (i) default commands to implement commonly used applications in response to predetermined device motion sequences, or (ii) user-defined commands mapped to device orientation, movements and rotation from among initial orientations of the electronic device, subsequent rotations of the electronic device in the palm of the user, rotations of the first housing around the hinge relative to the second housing, or any combination thereof.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

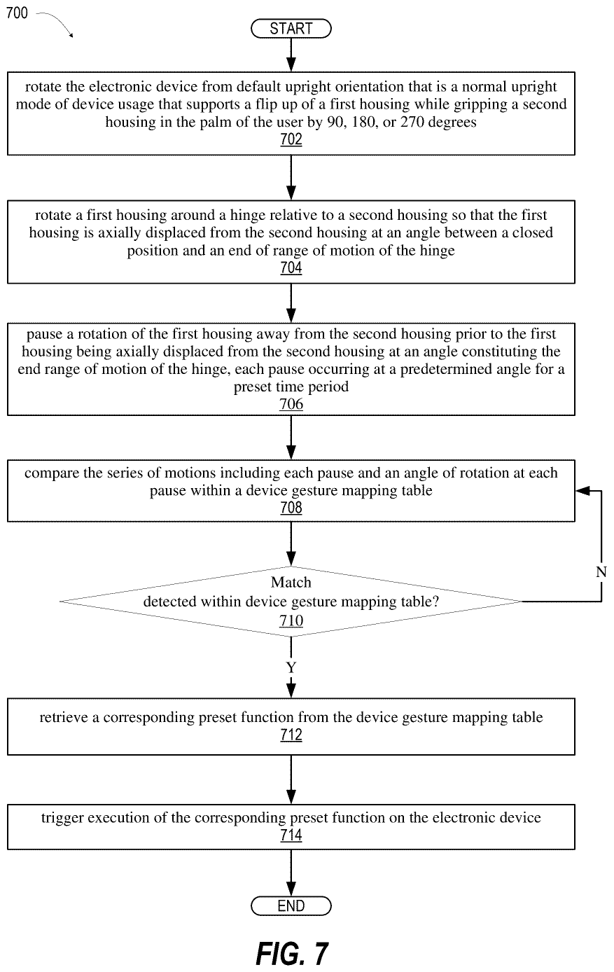

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc. In one embodiment, data storage subsystem 140 includes a gesture mapping table, such as presented by FIG. 7, and used as provided within the description of that figure.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of RTA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user 102. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more altimeters, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Other sensor(s) 157 may also include one or more rotational sensors 158d or spatial sensors 158e. Rotational sensor 158d measures the motion of the hinge separating the top and bottom portions of housing 105. The rotation sensor may be a rotary encoder, potentiometer or other device operative to measure rotation of the hinge and measure the degree of rotation between the two planes on either side of the hinge (e.g. the top and bottom portions of housing 105). Spatial sensor 158e measures the position of the electronic device 100 in relation to the user 102. Spatial sensors 158e can include pressure sensors operative to sense contact or changes in contact between the palm of the user 102 and housing 105. Proximity sensor 159a senses the presence of nearby objects. In one embodiment, proximity sensor 159a can be an infrared (IR) sensor that detects the presence of a nearby object, such as when electronic device 100 is in a pocket of a user 102. Electronic device 100 can also include one or more light sensors 159b, which detect the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface 154 can be utilized as an input device. The touch screen interface 154 can include one or more virtual buttons or selectable affordances. In one or more embodiments, when a user applies a finger or stylus on the touch screen interface 154 in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide multiple integrated displays within electronic device 100 and references to display(s) 161 are assumed to refer to one or all of these multiple integrated displays. Yet other embodiments can include external displays 165 that are not integrated into the main body of electronic device 100 but are wired or wirelessly connected to the other components of electronic device 100 to provide the input/output features similar to integrated display 161.

Vibration device 164 can cause electronic device 100 to vibrate or shake when activated. Vibration device 164 can be activated during an incoming call or message in order to provide an alert or notification to a user 102 of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of RTA module 125 and/or access to other applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIGS. 1C and 1D illustrate front and back flat views, respectively, of an example foldable electronic device, which is one implementation of electronic device 100. A flat view is presented when the electronic device 100 is in a fully axially displaced open position. Foldable electronic device 100 is presented as a flip phone having a top housing 105a and a bottom housing 105b that are connected via a centrally located hinge 60, according to one or more embodiments. FIG. 1C shows an example front display (or front facing display) 161a that extends across the entire front surface (or front facing surface) 10 of housing 105 of electronic device 100. FIG. 1D shows the hinge 60 connecting the top and bottom housings 105a and 105b. A logo 70 appears in the center of the back surface 30 of the bottom housing 105b. Top housing 105a also includes rear display (or rear facing display) 161b integrated into rear surface (or rear facing surface) 30 of top housing 105a. Integrated into front surface 10 of the top housing 105a are two front-facing cameras, main front facing camera 152a1 and front facing wide-angle camera or panoramic camera 152a2. Integrated into the rear surface of the top housing are three rear-facing cameras, rear facing telephoto camera 152b1, main rear facing camera 152b2, and rear facing wide-angle camera or panoramic camera 152b2. Top housing 105a may also include a first motion sensor or other sensor 157a and a second motion sensor or other sensor 157b. The numbers and locations of the cameras 152a1, 152a2, 152b1, 152b2, and 152b3 may vary with the description above in so far as there may be more or fewer front or rear cameras than described above and the front or rear cameras may be located at portions of the periphery of the front surface 10 that differ those described above or depicted in FIG. 1B and FIG. 1C or take the form of a camera under display (CUD).

FIGS. 1E and 1F illustrate top and bottom portions, respectively, of the flat view of electronic device 100 as shown in FIG. 1D, having the folding housing in the closed position, according to one or more embodiments. In this configuration, the hinge 60 is closed and the upper and lower portions of rear facing surface 30 are visible opposite each other while the upper and lower portions of front facing surface 10 (spanned by front facing display 161a) are adjacent to each other and not visible. Rear facing display 161b covers a portion of the top housing 105a, and may display visual content, such as time and date. In FIG. 1E, rear facing cameras 152b1, 152b2 and 152b3 and the second motion or other sensor 157b are also visible. In FIG. 1F, the logo 70 in the center of the back surface 30 of the bottom housing 105b is visible.

In the description of each of the following figures, reference is also made to specific components illustrated within the preceding figure(s). Similar or same components are presented with the same leading reference number.

FIGS. 2A-2D, 3A-3D, and 4A-4D illustrate the communication device 100 being reconfigured from a closed position in a first orientation to an axially displaced open position via different sequences of motions, each sequence corresponding to a command that effects a specific function, according to one or more embodiments. Between the initial closed position and the axially displaced open ending position, the electronic device 100 may be rotated in the palm of the user 102, while in the closed state. Such rotation is best described in terms of the three axes of the 3-dimensional Cartesian coordinate system. Horizontal movement occurs along the x-axis (East-West). Vertical movement occurs along the y-axis (North-South). Movement may also be measured in terms of height of depth along the z-axis. Motion sequences as described herein begin with the electronic device 100 in a faced-upwards orientation or a faced-downwards orientation in relation to the palm of the user 102. Rotation of the electronic device 100 in the palm of the user 102 such that the electronic device 100 maintains its initial faced-upwards or faced-downwards orientation occurs along the horizontal or longitudinal axis, the x-axis. Rotation of the electronic device in the palm of the user 102 such that the electronic device 100 transitions from a faced-upwards orientation to a faced-downwards orientation or vice versa occurs along the height/depth axis or z-axis. The controller 110 causes the electronic device 100 to sense the initial orientation of the electronic device 100 in the palm of the user 102 via at least one pressure sensor operative to sense the palm of the user on one of the first housing 105a or the second housing 105b of the electronic device 100. The controller 110 causes the electronic device 100 to sense motion following the electronic device 100 transitioning form its initial orientation via at least one accelerometer and at least one gyroscope operative to detect rotational movement of the electronic device 100. In accordance with the described embodiments, for the controller 110 to initiate the process of recognizing a sequence of movements as a device gesture, the electronic device must first be stationary in the palm of the user 102 in a faced-upwards orientation or a faced-downwards orientation for a period of time exceeding a preset threshold (e.g. 2 seconds). The electronic device 100 subsequently undergoes a combination of movements from among rotation along the longitudinal axis, rotation along the depth axis, and rotation of the first housing 105a away from and/or toward the second housing 105b along the plane of motion followed by the hinge 60 within a preset time period (e.g. 2-3 seconds). Pausing in a sequence of motions when rotating the first housing 105a toward or away from the second housing 105b along the plane of motion of the hinge 60 has to be for a predetermined time period (e.g. 1 second) to be recorded as part of a gesture sequence. Rotation of the electronic device in a closed position in the palm of the user along either the x-axis or the z-axis in a clockwise direction (e.g. 270 degrees clockwise) will be interpreted differently, resulting in the execution of a different command by the controller 110 than an equivalent rotation in a counterclockwise direction (e.g. 90 degrees counterclockwise).

FIGS. 2A-2D depict a plurality of specified sequences of motion whereby the communication device is reconfigured from a closed position to an axially displaced open position, each sequence corresponding to a command to effect/trigger a specific function, each of the respective sequences of motion having the same initial electronic device orientation, according to a plurality of embodiments.

FIG. 2A illustrates a first example process for implementing motion activated device actuation of applications or functions on an electronic device 100. The motion sequence begins with position 201A, which shows an initial orientation of the electronic device 100 in a closed configuration within the palm of the user 102 and in a faced-downwards orientation, presenting the back surface 30 of the bottom housing 105b of electronic device 100 facing away from the palm of the user. Here, the logo 70 in the center of the back surface 30 of the bottom housing 105b is upright. Position 201B is reached when the electronic device 100 is rotated from its initial orientation by a predetermined angle of 180 degrees clockwise along the longitudinal axis. The motion sequence ends at position 201C where the electronic device 100 is flipped to an axially displaced open position. According to the described embodiments, this sequence of motions is pre-programmed to activate (or trigger activation of) the Google application, which presents Google UI 221 on front facing display 20 of electronic device 100, as shown at 201D.

As an additional embodiment, in accordance with the disclosure, a rotation of 180 degrees counterclockwise along the longitudinal axis in the sequence of motions/movement described above would be considered a different gesture, resulting in a different command/operation on the electronic device 100.

FIG. 2B illustrates a second example process for implementing motion activated device actuation of applications or functions on an electronic device 100. The motion sequence again begins with position 201A, which shows an initial orientation of the electronic device 100 in a closed configuration within the palm of the user 102 and in a faced-downwards orientation, presenting the back surface 30 of the bottom housing 105b of electronic device 100 facing away from the palm of the user. Here, the logo 70 in the center of the back surface 30 of the bottom housing 105b is upright. Position 210A is reached when the electronic device 100 is rotated from its initial orientation by 180 degrees counterclockwise along the z-axis. This rotation places the electronic device 100 in a faced-upwards orientation. The motion sequence ends at position 210B when the top housing 105a of electronic device 100 is flipped to an axially displaced open position. According to the described embodiments, this sequence of motions is pre-programmed to activate (or trigger activation of) the Facebook application, which presents Facebook UI 222 on front facing display 20 of electronic device 100 as shown at 210C.

As an additional embodiment, in accordance with the disclosure, a rotation of 180 degrees clockwise along the depth axis in the sequence of motions/movement described above would be considered a different gesture, resulting in a different command/operation on the electronic device 100.

FIG. 2C illustrates a third example process for implementing motion activated device actuation of applications or functions on an electronic device 100. The motion sequence again begins with position 201A, which shows an initial orientation of the electronic device 100 in a closed configuration within the palm of the user 102 and in a faced-downwards orientation, presenting the back surface 30 of the bottom housing 105b of electronic device 100 facing away from the palm of the user. Here, the logo 70 in the center of the back surface 30 of the bottom housing 105b is upright. Position 220A is reached when the electronic device 100 is rotated by a predetermined angle of 180 degrees counterclockwise along the longitudinal axis. In accordance with the described features of the disclosure, while the electronic device 100 ends up in the same position reached after a rotation of 180 degrees clockwise along the longitudinal axis as shown in FIG. 2A, the rotation of 180 degrees counterclockwise along the longitudinal axis shown in FIG. 2C is interpreted differently by the controller 110, resulting in the activation of another application, as described below. The motion sequence ends at position 220B where the electronic device 100 is flipped to an axially displaced open position. According to the described embodiments, this sequence of motions is pre-programmed to activate the WhatsApp application, which presents WhatsApp UI 223 on front facing display 20 of electronic device 100, as shown at 220C.

FIG. 2D illustrates a fourth example process for implementing motion activated device actuation of applications or functions on an electronic device 100. The motion sequence again begins with position 201A, which shows an initial orientation of the electronic device 100 in a closed configuration within the palm of the user 102 and in a faced-downwards orientation, presenting the back surface 30 of the bottom housing 105b of electronic device 100 facing away from the palm of the user. Here, the logo 70 in the center of the back surface 30 of the bottom housing 105b is upright. Position 230A is reached when the electronic device 100 is rotated by a predetermined angle of 180 degrees clockwise along the depth axis. Again, in accordance with the disclosure, while the electronic device 100 ends up in the same position reached after a rotation of 180 degrees counterclockwise along the depth axis as shown in FIG. 2B, the rotation of 180 degrees clockwise shown in FIG. 2D is interpreted differently by the controller 110, resulting in the activation of another application, as described below. The motion sequence ends at position 230B where the electronic device 100 is flipped to an axially displaced open position. According to the described embodiments, this sequence of motions is pre-programmed to activate the Disney+ application, which presents Disney+ UI 224 on front facing display 20 of electronic device 100, as shown at 230C. In some embodiments, as the electronic device 100 ended in an upside-down orientation when flipped into an axially displaced position, it will/can in practice, be returned to an upright axially displaced open position by the user 102 before the application is used. However, in other embodiments, the content of the application user interface is automatically rotated 180 degrees to be viewed right side up, even though the electronic device is physically upside down.

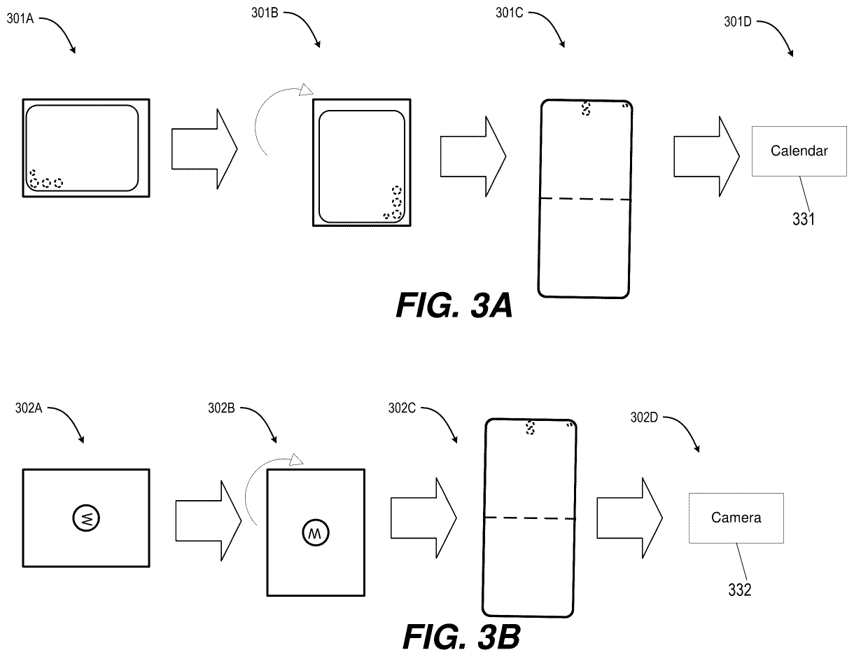

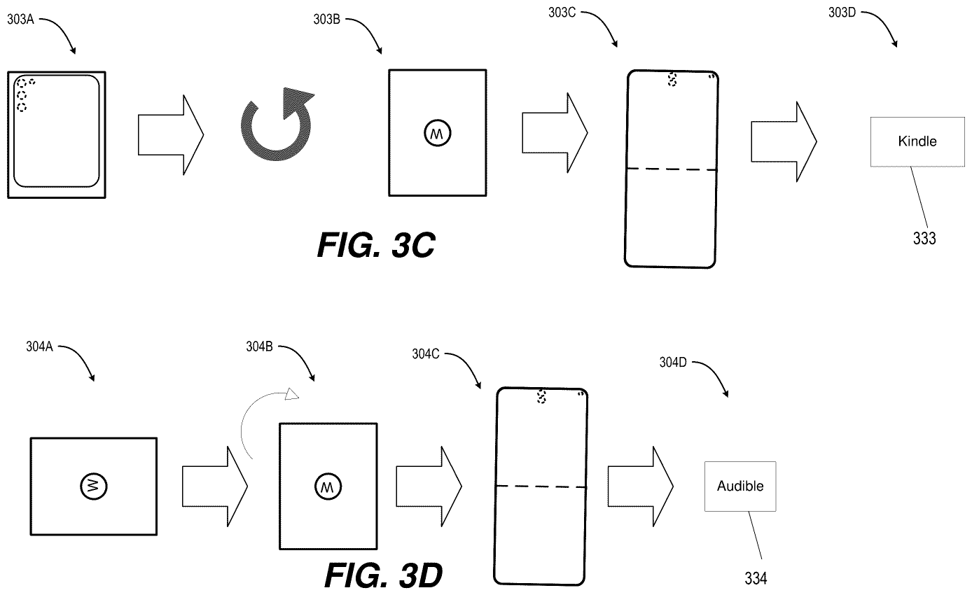

FIGS. 3A-3D depict a second plurality of different sequences of motion whereby the communication device is reconfigured from a closed position to an axially displaced open position, each sequence corresponding to a command to effect/trigger a specific function, according to a plurality of embodiments. With this series of figures, each of the respective sequences of motion has a different initial electronic device orientation.

FIG. 3A illustrates a fifth example process for implementing motion activated device actuation of applications or functions on an electronic device 100. The motion sequence begins with position 301A, which shows an initial orientation of the electronic device 100 in a closed configuration within the palm of the user 102 and in a faced-upwards orientation, presenting the back surface 30 of the top housing 105a of the electronic device 100 facing away from the palm of the user. Here the rear facing display 161b is 90 degrees clockwise from upright. Position 301B is reached when the electronic device 100 is rotated from its initial orientation by a predetermined angle of 270 degrees clockwise. The motion sequence ends at position 301C where the electronic device 100 is flipped to an axially displaced open position. According to the described embodiments, this sequence of motions is pre-programmed to activate the Calendar application, which presents Calendar UI 331 on front facing display 20 of electronic device 100, as shown at 301d.

FIG. 3B illustrates a sixth example process for implementing motion activated device actuation of applications or functions on an electronic device 100. The motion sequence begins with position 302A, which shows an initial orientation of the electronic device 100 in a closed configuration within the palm of the user 102 in a faced-downwards orientation presenting the back surface 30 of the bottom housing 105b electronic device 100 facing away from the palm of the user. Here the logo 70 in the center of the back surface 30 of the bottom housing 105b is 90 degrees clockwise from upright. Position 302B is reached when the electronic device 100 is rotated 90 degrees clockwise along the longitudinal axis. The motion sequence ends at position 302C, which is reached when the electronic device 100 is flipped to an axially displaced open position. According to the described embodiments, this sequence of motions is pre-programmed to activate the Camera application, which presents Camera UI 332 on front facing display 20 of electronic device 100, as shown at 302D.

FIG. 3C illustrates a seventh example process for implementing motion activated device actuation of applications or functions on an electronic device 100. The motion sequence begins with position 303A, which shows an initial orientation of the electronic device 100 in a closed configuration within the palm of the user 102 and in a faced-upwards orientation, presenting the back surface 30 of the top housing 105a of the electronic device 100 facing away from the palm of the user. Here the rear facing display 161b is 180 degrees clockwise from upright. Position 303B is reached when the electronic device 100 is rotated by a predetermined angle of 180 degrees counterclockwise along the depth axis. Position 303C is reached when the electronic device 100 is flipped to an axially displaced open position. According to the described embodiments, this sequence of motions is pre-programmed to activate the Kindle application, which presents Kindle UI 333 on front facing display 20 of electronic device 100, as shown at 303D. As the electronic device 100 ended in a horizontal orientation and with the front display 20 facing down (e.g. away from the user 102) when flipped into an axially displaced position, it will in practice, be returned to an upright axially displaced open position and rotated so that the front display 20 is face up by the user 102 before the application is used.

FIG. 3D illustrates an eighth example process for implementing motion activated device actuation of applications or functions on an electronic device 100. The motion sequence again begins with initial/starting position 304A, which shows an initial orientation of the electronic device 100 in a closed configuration within the palm of the user 102 and in a faced-upwards orientation, presenting the back surface 30 of the top housing 105a of the electronic device 100 facing away from the palm of the user 102. Position 304B is reached when the electronic device 100 is rotated by a predetermined angle of 180 degrees counterclockwise along the latitudinal axis. The motion sequence ends at position 304C where the electronic device 100 is flipped to an axially displaced open position. According to the described embodiments, this sequence of motions is pre-programmed to activate the Audible application, which presents Audible UI 334 on front facing display 20 of electronic device 100, as shown at 304D.

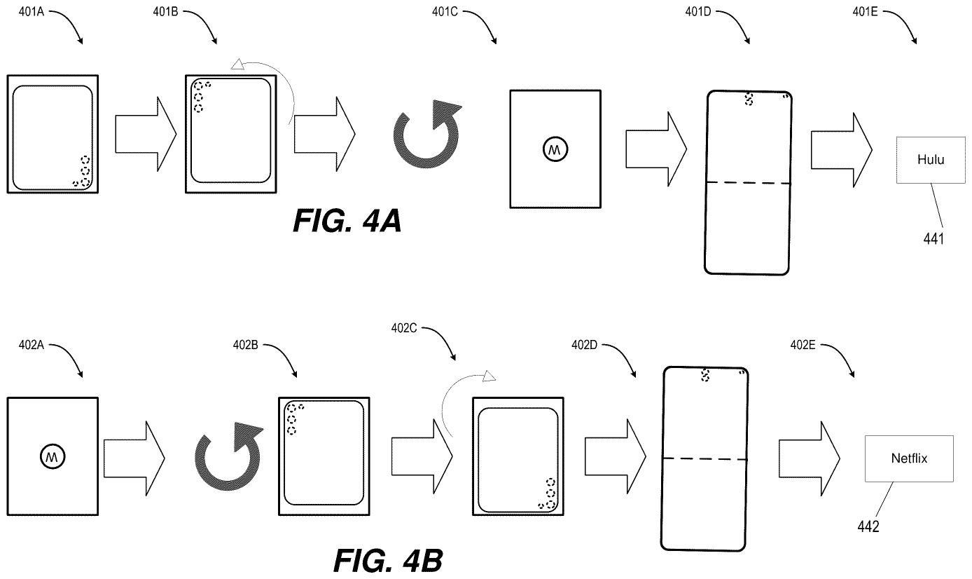

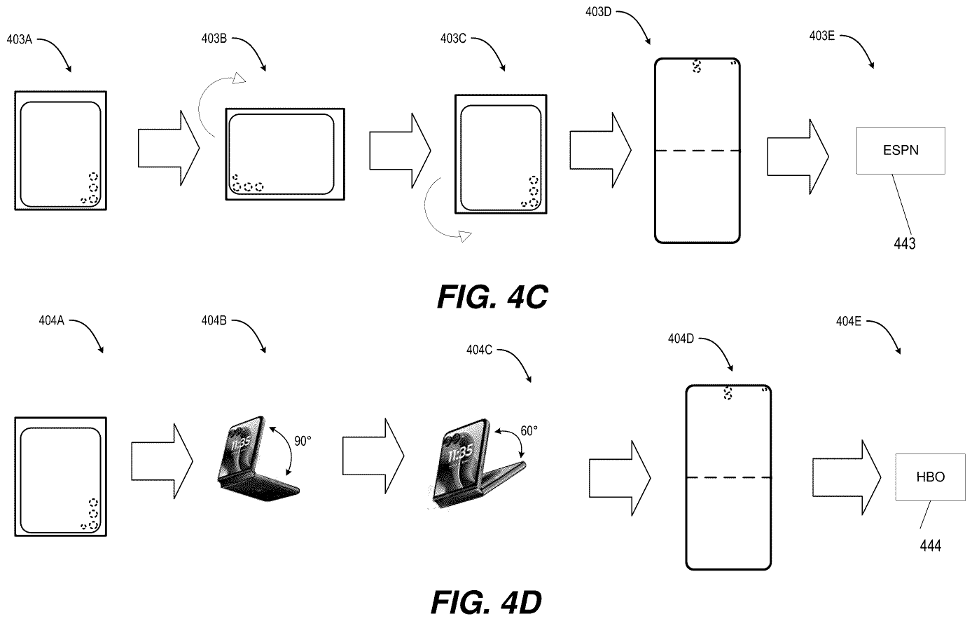

FIGS. 4A-4D depict a third plurality of different sequences of motions whereby the communication device 100 is reconfigured from a closed position to an axially displaced open position, each sequence of motions including two of a rotation of the electronic device along the longitudinal axis, a rotation of the electronic device 100 along the depth axis, or pausing and/or reversing the rotation of the first housing 105a while displacing the first housing 105a axially from the second housing 105b before the electronic device reaches an axially displaced open position, according to a plurality of embodiments.

FIG. 4A illustrates a ninth example process for implementing motion activated device actuation of applications or functions on an electronic device 100. The motion sequence begins with position 401A, which shows an initial orientation of the electronic device 100 in a closed configuration within the palm of the user 102 in a faced-upwards orientation presenting the back surface 30 of the top housing 105a of the electronic device 100 facing away from the palm of the user. Here the rear facing display 161b is upright. Position 401B is reached when the electronic device 100 is rotated from its initial orientation along the x-axis by a predetermined 180 degrees counterclockwise. Position 401C is reached when the electronic device 100 is rotated by 180 degrees counterclockwise along the z-axis. This rotation places the electronic device 100 in a faced-downwards orientation. The motion sequence ends at position 401D where the electronic device 100 is flipped to an axially displaced open position. According to the described embodiments, this sequence of motions is pre-programmed to activate the Hulu application, which presents Hulu UI 441 on front facing display 20 of electronic device 100, as shown at 401E. As the electronic device 100 ended with the front display 20 facing down (e.g. away from the user 102) when flipped into an axially displaced position, it will in practice, be rotated so that the front display 20 is face up by the user 102 before the application is used.

FIG. 4B illustrates a tenth example process for implementing motion activated device actuation of applications or functions on an electronic device 100. The motion sequence begins with position 402A (identical to position 301A), which shows an initial orientation of the electronic device 100 in a closed configuration within the palm of the user 102 in a faced-downwards orientation presenting the back surface 30 of the bottom housing 105b of the electronic device 100 facing away from the palm of the user. Here the logo 70 in the center of the back surface 30 of the bottom housing 105b is 180 degrees clockwise from upright. Position 402B is reached when the electronic device 100 is rotated 180 degrees counterclockwise along the z-axis. This rotation places the electronic device 100 in a faced-upwards orientation. Position 402C is reached when the electronic device 100 is rotated 180 degrees clockwise along the longitudinal axis. The motion sequence ends at position 402D where the electronic device 100 is flipped to an axially displaced open position. According to the described embodiments, this sequence of motions is pre-programmed to activate the Netflix application, which presents Netflix UI 442 on front facing display 20 of electronic device 100, as shown at 402E.

FIG. 4C illustrates an eleventh example process for implementing motion activated device actuation of applications or functions on an electronic device 100. The motion sequence begins with initial/starting position 403A (identical to position 201A), which shows an initial orientation of the electronic device 100 in a closed configuration within the palm of the user 102 in a faced-upwards orientation presenting the back surface 30 of the top housing 105a of the electronic device 100 facing away from the palm of the user 102. Here the rear display 161b is upright. Position 403B is reached when the electronic device 100 is rotated from its initial orientation by a predetermined angle of 90 degrees clockwise along the longitudinal axis. Position 403C is reached when the electronic device 100 is subsequently rotated additional 90 degrees counterclockwise along the longitudinal axis. The motion sequence ends at position 403D where the electronic device 100 is flipped to an axially displaced open position. According to the described embodiments, this sequence of motions is pre-programmed to activate (or trigger activation of) the ESPN application, which presents ESPN UI 443 on front facing display 20 of electronic device 100, as shown at 403E.

FIG. 4D illustrates a twelfth example process for implementing motion activated device actuation of applications or functions on an electronic device 100. The motion sequence begins with initial/starting position 404A (identical to position 201A), which shows an initial orientation of the electronic device 100 in a closed configuration within the palm of the user 102 in a faced-upwards orientation presenting the back surface 30 of the top housing 105a of the electronic device 100 facing away from the palm of the user 102. Here the rear display 161b is upright. Position 404B is reached when the first housing 105a is rotated away from the second housing 105b along the plane of motion along which the hinge moves until the first housing 105a and the second housing 105b are axially displaced by 90 degrees. Position 404C is reached when the first housing 105a is closed relative to the second housing 105b by 30 degrees along the plane of motion along which the hinge moves, resulting in the first housing 105a and the second housing 105b being axially displaced by 60 degrees. The motion sequence ends at position 404D where the electronic device 100 is flipped from the 60 degree displacement to an axially displaced fully open position. According to the described embodiments, this sequence of motions is pre-programmed to activate (or trigger activation of) the HBO application, which presents HBO UI 444 on front facing display 20 of electronic device 100, as shown at 404E.

According to one implementation feature, while the majority of the motion sequences shown in FIGS. 2A-2D, FIGS. 3A-3D, and FIGS. 4A-4D end with the electrical device in an upright position, this is not required to invoke an application or mode of operation on the electronic device 100. If the electronic device ends a motion sequence with the device upside down (as shown in FIG. 3D) or in a horizontal position, the motion sequence will still be interpreted as the predetermined command corresponding to the motion sequence and trigger the implementation of the associated application or mode of operation. The electronic device 100 will automatically rotate the content of the application user interface to an upright position for the convenience of the user, once the electronic device reaches an axially open position (e.g., when the motion sequence ends).

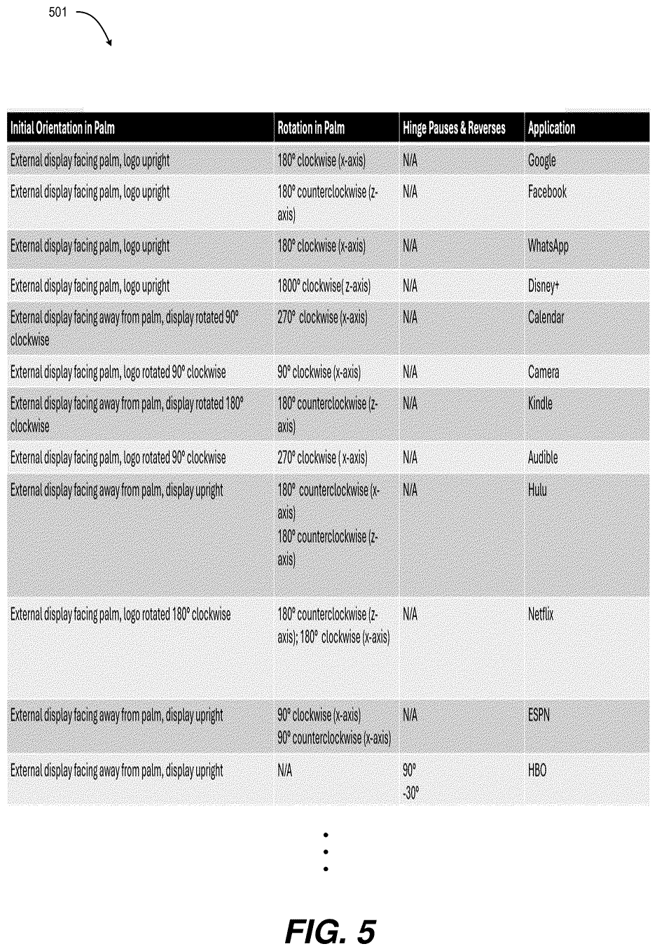

FIG. 5 depicts an exemplary device gesture mapping table populated with predetermined commands and corresponding applications or modes of operation executed when the electronic device 100 is reconfigured from a closed position in a starting/initial position and orientation to an axially displaced open position, according to one or more embodiments. The table characterizes each sequence of motions corresponding to a predetermined command based on the initial orientation of the electronic device 100 in the palm of the hand of the user, and subsequent rotation of the phone in the depth axis, rotation of the phone in the longitudinal axis, partial opening including pausing and reversing direction, and axially displaced opening up to the limit of the range of motion of the hinge 60 separating the first housing 105a and second housing 105b of the electronic device 100. The predetermined commands include default commands corresponding to commonly used applications, and user-defined commands that have been mapped to device orientation, movements and rotation from among initial orientations of the electronic device, subsequent rotations of the electronic device in the palm of the user, rotations of the first housing 105a around the hinge 60 relative to the second housing 105b, or any combination thereof. The sequence of motions includes at least two movements. While the table presents specific example sequences of motions and corresponding applications or modes of operation illustrated in the exemplary FIGS. 2A-2D, 3A-3D, and 4A-4D, different and/or additional sequences of motion/device movements corresponding to additional predetermined commands, operative to effect the execution of additional applications and modes of operation, are also contemplated. For example, device gestures may be mapped to a predetermined command to unlock the electronic device. Once opened in response to this unlock command the device does not require additional authentication for logging in. However, in at least some embodiments, the automatic gesture-based initiation of a particular application or mode of operation on the electronic device provides access to just that application or mode of operation, and subsequent user authentication is required to access the full set of applications and modes of operation on the device. Additionally, the specific commands that are shown linked to specific sequences are for example only and the association of the commands with specific sequences can be modified on a device level, in some embodiments.

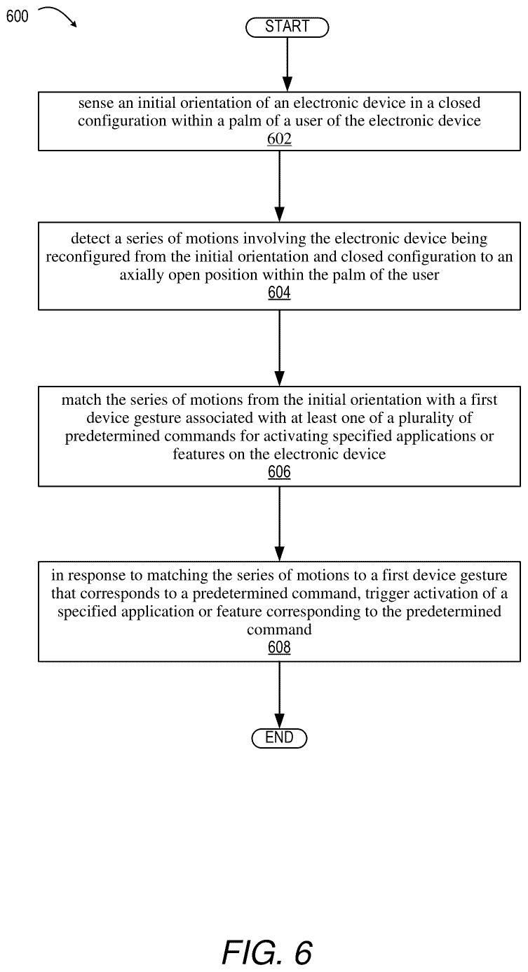

Referring now to the flowcharts presented by FIG. 6 and FIG. 7, the descriptions of the methods in FIG. 6 and FIG. 7 are provided with general reference to the specific components and features illustrated within preceding FIGS. 1A-1C, 2A-2D, 3A-3D, 4A-4D, and 5. Specific components referenced in the methods of FIG. 6 and FIG. 7 may be identical or similar to components of the same name used in describing preceding FIGS. 1A-1C, 2A-2D, 3A-3D, 4A-4D, and 5. In one or more embodiments, controller 110 (FIG. 1) is configured to cause the electronic device 100 (FIG. 1) to provide the described functionality of the methods of FIG. 6 and FIG. 7 by executing program code for one or more modules or applications provided within device data storage 140 of first electronic device 100, including RTA module 125 (FIG. 1).

FIG. 6 depicts a flow diagram presenting a method for motion activated device actuation, according to one or more embodiments. The method 600 begins at block 602, where controller 110 causes the electronic device 100 to sense an initial orientation of an electronic device 100 in a closed configuration within a palm of a user 102 of the electronic device 100. The method continues to block 604, where controller 110 causes the electronic device 100 to detect a sequence of motions involving the electronic device 100 being reconfigured from the initial orientation and closed configuration to an axially open position within the palm of the user 102. The method continues to block 606, where controller 110 causes the electronic device 100 to match the sequence of motions from the initial orientation with a first device gesture associated with at least one of a plurality of predetermined commands for activating specified applications or features on the electronic device 100. The method continues to block 608, where controller 110 causes the electronic device 100 to, in response to matching the sequence of motions to a first device gesture that corresponds to a predetermined command, trigger activation of a specified application or feature corresponding to the predetermined command. Then the method ends.

FIG. 7 depicts a flow diagram presenting an additional method for motion activated device actuation, according to one or more embodiments. The method 700 begins at block 702, where controller 110 causes the electronic device 100 to sense the electronic device 100 rotating in the palm of the user 102 along the longitudinal axis. As an example, electronic device 100 can be rotated one of 90, 180, or 270 degrees or some other number of degrees from a starting position of zero degrees. It is appreciated that the sensor may be configured to allow a variation in (or acceptable range across) the actual number of degrees of rotation (e.g., plus or minus 5 degrees), such that a 90-degree rotation would encompass 85-95 degree rotations of the electronic device. The method continues to block 704, where controller 110 causes the electronic device 100 to rotate a first housing 105a around a hinge 60 relative to a second housing 105b so that the first housing 105a is axially displaced from the second housing 105b at an angle between a closed position and an end of range of motion of the hinge 60. The method proceeds to block 706, where controller 110 causes the electronic device 100 to pause rotation of the first housing 105a away from the second housing 105b prior to the first housing 105a being axially displaced from the second housing 105b at an angle constituting the end range of motion of the hinge 60, each pause occurring at a predetermined angle for a preset time period. The method proceeds to block 708, where controller 110 causes the electronic device 100 to compare the sequence of motions including each pause and a measured angle of rotation at each pause within a device gesture mapping table. The method proceeds to block 410, where a decision is made regarding whether a match for the sequence of motions is found in the gesture mapping table. If no match is found, the method returns to block 708. If a match is found, the method proceeds to block 412, where controller 110 causes the electronic device 100 to retrieve a corresponding preset function from the device gesture mapping table. The method proceeds to block 412, where controller 110 causes the electronic device 100 to trigger execution of the corresponding preset function on the electronic device 100. Then the method ends.

Accordingly, by implementing the above-described processes, a user of an electronic device may activate an application or mode of operation with single handed horizontal and vertical rotational movements of the device using the wrist, palm, and fingers to open the device. The described methods represent an improvement over existing methods of initiating such programs on devices such as smartphones which require engagement with both hands and scrolling through myriad options on a display. The prescribed methods allow a user to access such functionality without looking at a screen or manually contacting buttons or a tactile display. Programs can be selected to open quickly and reliably in darkness, or when the view of the device is obstructed. An acquaintance unfamiliar with the operating system of the device can be easily shown how to access features without excessive instruction. The improvements contemplated herein make using the most commonly accessed programs on a device an altogether smoother process.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regard to the sequence of operations without departing from the spirit or scope of the present innovation. Use of a particular sequence is therefore not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed

1. An electronic device comprising:
a foldable enclosure comprising a first housing and a second housing coupled by a hinge such that the first housing is pivotable about the hinge relative to the second housing between a closed position and an axially displaced open position;
at least one image capturing device comprising a first rear facing camera embedded in a first surface of the first housing, the first surface being an outward facing surface of the first housing;
a plurality of sensors comprising:
at least one pivot sensor operable to determine: an angle of rotation when the first housing is pivoted about the hinge relative to the second housing; and a configuration of the electronic device between the closed position, a partially open substantially orthogonal position, and the axially displaced open position; and
one or more device spatial sensors operative to detect a relative orientation and position of the electronic device, while in the closed position and supported in a palm of a hand of a user;
a memory having stored thereon a rotation, translation, and activation (RTA) module that configures the electronic device to interpret opening of the device housing following different initial device orientations as different activation gestures for respectively activating applications and other features on the electronic device; and
at least one processor communicatively coupled to the at least one image capturing device, each of the plurality of sensors, and the memory, the at least one processor executing program code of the RTA module, and configured to cause the electronic device to:
sense an initial orientation of the electronic device in a closed configuration within the palm of the user;
detect a sequence of motions involving the electronic device being reconfigured from the initial orientation and closed configuration to an axially open position within the palm of the user;
match the sequence of motions from the initial orientation with a first device gesture associated with at least one of a plurality of predetermined commands for activating specified applications or features on the electronic device; and
in response to matching the sequence of motions to a first device gesture that corresponds to a predetermined command, trigger activation of a specified application or feature corresponding to the predetermined command.

2. The electronic device of claim 1, wherein prior to triggering activation of the specified application or feature, the at least one processor is configured to cause the electronic device to:
prompt the user to confirm an intention to invoke the predetermined command; and
initiate triggering of the activation, in response to receipt of confirmation that the user intended to invoke the predetermined command.

3. The electronic device of claim 1, wherein the initial orientation is one from among a group of different hand held orientations comprising (i) a plurality of faced-upwards orientations presenting the first surface of the electronic device facing away from the palm of the user and (ii) a plurality of faced-downwards orientations with the first surface facing and covered by the palm of the user, with a second surface of the electronic device, opposed to the first surface, facing away from the palm of the user.

4. The electronic device of claim 3, wherein the plurality of faced-upwards orientations and faced-downwards orientations comprise: a default upright orientation that is a normal upright mode of device usage that supports a flip up of the first housing while gripping the second housing in the palm of the user; and one or more of: a second orientation rotated 90 degrees clockwise from the default orientation; a third orientation rotated 180 degrees from the default orientation; and a fourth orientation that is rotated 270 degrees clockwise or −90 degrees counter-clockwise from the default orientation, wherein the default orientation is a zero phase orientation.

5. The electronic device of claim 1, wherein the sequence of motions comprise at least two sequential motions from among rotating the electronic device in the palm of the user from an initial default orientation along a height/depth axis, rotating the electronic device in the palm of the user along a longitudinal axis by a preset number of degrees, and rotating the first housing relative to the second housing so that the first housing is axially displaced from the second housing at an angle between a closed position and an end of range of motion of the hinge.

6. The electronic device of claim 1, wherein:
the sequence of motions further comprises pauses in a rotation of the first housing away from or towards the second housing prior to the first housing being axially displaced at a final angle between a closed position and a fully open position with the second housing, each pause occurring at a predetermined intermediate angle for a preset time period, the rotations being uni-directional or bi-directional rotations; and
the at least one processor is configured to cause the electronic device to:
compare the sequence of motions including each pause and an angle/amount of rotation at each pause within a device gesture mapping table; and
in response to detecting a match of the sequence of motions within the device gesture mapping table:
retrieve a corresponding preset function from the device gesture mapping table; and
trigger execution of the corresponding preset function on the electronic device.

7. The electronic device of claim 1, where the one or more spatial sensors comprise pressure sensors operative to sense the palm of the user on one of the first housing or the second housing.

8. The electronic device of claim 1, wherein the one or more sensors comprise at least one accelerometer and at least one gyroscope operative to detect rotational movement of the electronic device in a closed position.

9. The electronic device of claim 1, wherein the predetermined commands for activating specified applications or features on the electronic device comprise:
default commands corresponding to commonly used applications; or
user-defined commands mapped to device orientation, movements and rotation from among initial orientations of the electronic device, subsequent rotations of the electronic device in the palm of the user, rotations of the first housing around the hinge relative to the second housing, or any combination thereof.

10. A method comprising:
sensing an initial orientation of an electronic device in a closed configuration within a palm of a user of the electronic device;
detecting a sequence of motions involving the electronic device being reconfigured from the initial orientation and closed configuration to an axially open position within the palm of the user;
matching the sequence of motions from the initial orientation with a first device gesture associated with at least one of a plurality of predetermined commands for activating specified applications or features on the electronic device; and
in response to matching the sequence of motions to a first device gesture that corresponds to a predetermined command, trigger activation of a specified application or feature corresponding to the predetermined command.

11. The method of claim 10, wherein the initial orientation is one from among a group of different hand held orientations from among a plurality of faced-upwards orientations presenting a first surface of the electronic device facing away from the palm of the user and a plurality of faced-downwards orientations with the first surface facing and covered by the palm of the user and a second surface of the electronic device, opposed to the first surface, facing upwards, away from the palm of the user.

12. The method of claim 10, wherein a plurality of faced-upwards orientations and faced-downwards orientations comprise a default upright orientation that is a normal upright mode of device usage that supports a flip up of a first housing while gripping a second housing in the palm of the user, a second orientation rotated 90 degrees clockwise from the default orientation, a third orientation rotated 180 degrees from the default orientation, and a −90 degrees orientation rotated 270 degrees clockwise from the default orientation, wherein the default orientation is a zero phase orientation.

13. The method of claim 10, wherein in executing the sequence of motions, the method further comprises:
rotating the electronic device in the palm of the user from its initial default orientation by a preset number of degrees; and
rotating a first housing around a hinge relative to a second housing so that the first housing is axially displaced from the second housing at an angle between a closed position and an end of range of motion of the hinge.

14. The method of claim 13, wherein the method further comprises:
in executing the sequence of motions, pausing a rotation of the first housing away from the second housing prior to the first housing being axially displaced from the second housing at an angle constituting the end range of motion of the hinge, each pause occurring at a predetermined angle for a preset time period;
comparing the sequence of motions including each pause and an angle of rotation at each pause within a device gesture mapping table; and
in response to detecting a match within the device gesture mapping table: retrieving a corresponding preset function from the device gesture mapping table; and triggering execution of the corresponding preset function on the electronic device.

15. The method of claim 10, wherein in executing the sequence of motions, the method further comprises rotating a first housing around a hinge relative to a second housing so that the first housing is axially displaced from the second housing at an angle between a closed position and an end of range of motion of the hinge.

16. The method of claim 10, wherein in detecting a relative orientation and position of the electronic device, while in the closed position and supported in a palm of a hand of the user, the method further comprises sensing via at least one pressure sensor the palm of the user on one of a first housing or a second housing.

17. A computer program product comprising a non-transitory computer readable medium having program instructions that when executed by a processor of an electronic device, configure the electronic device to perform functions comprising:
sensing an initial orientation of the electronic device in a closed configuration within a palm of a user of the electronic device;
detecting a sequence of motions involving the electronic device being reconfigured from the initial orientation and closed configuration to an axially open position within the palm of the user;
matching the sequence of motions from the initial orientation with a first device gesture associated with at least one of a plurality of predetermined commands for activating specified applications or features on the electronic device; and
in response to matching the sequence of motions to a first device gesture that corresponds to a predetermined command, trigger activation of a specified application or feature corresponding to the predetermined command.

18. The computer program product of claim 17, further comprising program instructions for, in executing the sequence of motions:
rotating the electronic device in the palm of the user from its initial default orientation by a preset number of degrees; and
rotating a first housing around a hinge relative to a second housing so that the first housing is axially displaced from the second housing at an angle between a closed position and an end of range of motion of the hinge.

19. The computer program product of claim 18, further comprising program instructions for:
in executing the sequence of motions, pausing a rotation of the first housing away from the second housing prior to the first housing being axially displaced from the second housing at an angle between a closed position and an end of range of motion of the hinge, each pause occurring at a predetermined angle for a preset time period;
comparing the sequence of motions including each pause and an angle of rotation at each pause within a device gesture mapping table; and
in response to detecting a match within the device gesture mapping table: retrieving a corresponding preset function from the device gesture mapping table; and triggering execution of the corresponding preset function on the electronic device.

20. The computer program product of claim 17, further comprising program instructions for, in in executing the sequence of motions:
rotating a first housing around a hinge relative to a second housing so that the first housing is axially displaced from the second housing at an angle between a closed position and an end of range of motion of the hinge.
